(19) United States
(12) Patent Application Publication
(10) Pub. No.: US 2017/0120854 A1
(43) Pub. Date: May 4, 2017

(54) AIRBAG DEVICE FOR DRIVER'S SEAT

(71) Applicant: TOYOTA JIDOSHA KABUSHIKI KAISHA, Toyota-shi (JP)

(72) Inventors: Osamu FUKAWATASE, Miyoshi-shi (JP); Atsushi NAKASHIMA, Toyota-shi (JP)

(73) Assignee: TOYOTA JIDOSHA KABUSHIKI KAISHA, Toyota-shi (JP)

(21) Appl. No.: 15/258,591

(22) Filed: Sep. 7, 2016

(30) Foreign Application Priority Data
Oct. 30, 2015 (JP) 2015-215164

(51) Int. Cl. B60R 21/231; B60R 21/264; B60R 21/203

(52) U.S. Cl. CPC B60R 21/231; B60R 21/2035; B60R 21/264; B60R 2021/0004

(57) ABSTRACT

An airbag device for a driver's seat, includes: an inflator; a main body airbag that receives a supply of gas from the inflator and is inflated and expanded at a vehicle rear side of a steering wheel; and an annular airbag that is connected to an outer peripheral portion of a rear surface at a vehicle rear side of the main body airbag, and that receives a supply of gas from the main body airbag and is inflated and expanded from the outer peripheral portion toward a vehicle rear side, and whose inflated and expanded state, as seen from the axial direction rear side of the steering wheel, is formed in an annular shape having an outer diameter that is larger than an outer diameter of the main body airbag and having an inner diameter that is smaller than the outer diameter of the main body airbag.

### CROSS-REFERENCE TO RELATED APPLICATION

This application is based on and claims priority under 35 USC 119 from Japanese Patent Application No. 2015-215164 filed on Oct. 30, 2015, the disclosure of which is incorporated by reference herein.

### BACKGROUND

Technical Field

The present disclosure relates to an airbag device for a driver's seat.

Related Art

As an airbag device for a driver's seat, there is an airbag device for a driver's seat in which a connecting portion of an opposite-occupant-side base cloth of an airbag and a tether, that regulates the thickness of the airbag, is disposed on the rim of a steering wheel (see, for example, Japanese Patent Application Laid-Open (JP-A) No. 2008-094224).

Note that as techniques relating to airbag devices, in addition to JP-A No. 2008-094224, there are, for example, JP-A No. 2015-116912, JP-A No. 2015-024729, JP-A No. 2007-296980 and JP-A No. 2008-062714.

There is the following concern when the head portion of the occupant seated in the driver's seat (hereinafter appropriately called the “occupant head portion”) moves toward a vehicle obliquely front side accompanying an oblique collision in which a collision body collides obliquely with the vehicle front surface. Namely, because the occupant head portion contacts the outer peripheral side of the airbag that has been inflated and expanded in the shape of a flat sphere, there is the possibility that the occupant head portion will rotate around an axis that runs along the vertical direction of the occupant head portion.

### SUMMARY

Thus, an object of the present disclosure is to, in a case in which an occupant head portion contacts the outer peripheral side of an airbag that has been inflated and expanded accompanying an oblique collision, suppress rotation of the occupant head portion around an axis that runs along the vertical direction of the occupant head portion.

An airbag device for a driver's seat relating to a first aspect includes: an inflator that is provided at a steering wheel, and that generates gas at a time of a collision or a time when a collision is predicted; a main body airbag that receives a supply of gas from the inflator and is inflated and expanded at a vehicle rear side of the steering wheel, and whose inflated and expanded state, as seen from an axial direction rear side of the steering wheel, is formed in a circular shape; and an annular airbag that is connected to an outer peripheral portion of a rear surface at a vehicle rear side of the main body airbag, and that receives a supply of gas from the main body airbag and is inflated and expanded from the outer peripheral portion toward a vehicle rear side, and whose inflated and expanded state, as seen from the axial direction rear side of the steering wheel, is formed in an annular shape having an outer diameter that is larger than an outer diameter of the main body airbag and having an inner diameter that is smaller than the outer diameter of the main body airbag.

In accordance with the above-described airbag device for a driver's seat, when gas is supplied from the inflator to the main body airbag accompanying an oblique collision, the main body airbag is inflated and expanded at the vehicle rear side of the steering wheel. When the inflated and expanded state of this main body airbag is viewed from the vehicle rear side, the main body airbag is formed in a circular shape.

Further, the annular airbag is connected to the outer peripheral portion of the rear surface at the vehicle rear side of the main body airbag. Accompanying the inflation and expansion of the main body airbag, this annular airbag receives a supply of gas from the main body airbag and is inflated and expanded toward the vehicle rear side from the outer peripheral portion of the main body airbag. Further, when the inflated and expanded state of the annular airbag is viewed from the axial direction rear side of the steering wheel, the annular airbag is formed in an annular shape having the outer diameter that is larger than the outer diameter of the main body airbag and having the inner diameter that is smaller than the outer diameter of the main body airbag.

Due thereto, when the occupant head portion moves toward a vehicle obliquely front side accompanying an oblique collision, the occupant head portion passes-through the inner side of the annular airbag (within the inner peripheral circle) and contacts the outer peripheral side of the main body airbag that is in the inflated and expanded state. Or, the occupant head portion contacts both the outer peripheral side of the main body airbag that is in the inflated and expanded state and the inner peripheral surface of the annular airbag. At this time, when, accompanying the contact of the main body airbag and the occupant head portion, the occupant head portion rotates around the axis that runs along the vertical direction of the occupant head portion, the occupant head portion contacts the inner peripheral surface of the annular airbag. Or, the occupant head portion, that has contacted the inner peripheral surface of the annular airbag, is pushed further against this inner peripheral surface. Due thereto, rotation of the occupant head portion is suppressed.

Further, as described above, when the inflated and expanded state of the annular airbag is viewed from the axial direction rear side of the steering wheel, the annular airbag is formed in an annular shape having the outer diameter that is larger than the outer diameter of the main body airbag and having the inner diameter that is smaller than the outer diameter of the main body airbag. Due thereto, while the thickness (the size) in the radial direction of the annular airbag that is in the inflated and expanded state is ensured, collapsing-in of the annular airbag toward the radial direction outer side, that accompanies the contact between the occupant head portion and the annular airbag, can be suppressed.

Moreover, even in a case in which the main body airbag and the annular airbag are inflated and expanded in a state in which the steering wheel has been rotated, the inner peripheral surface of the annular airbag is expanded at the vehicle transverse direction both sides of the main body airbag. Namely, the occupant head portion can be received by the inner peripheral surface of the annular airbag regardless of the angle of rotation of the steering wheel.

In an airbag device for a driver's seat relating to a second aspect, in the airbag device for a driver's seat relating to the first aspect, a plural supply holes, that are disposed with an interval therebetween in a peripheral direction of the annular airbag and through which gas is supplied from the main body airbag, are formed in the annular airbag.

In accordance with the above-described airbag device for a driver's seat, plural supply holes, that are disposed with an interval therebetween in the peripheral direction of the annular airbag, are formed in the annular airbag. Gas is supplied from the main body airbag to the annular airbag via these supply holes. As a result, the annular airbag is inflated and expanded.

Therefore, the pressure within the annular airbag (the internal pressure) at the time when the occupant head portion contacts the inner peripheral surface of the annular airbag can be adjusted by changing the number of or the size of the plural supply holes. Namely, the force by which the inner peripheral surface of the annular airbag restrains the occupant head portion can be adjusted by changing the number or the size of the plural supply holes. Accordingly, rotation of the occupant head portion can be suppressed more effectively.

As described above, in the above-described airbag device for a driver's seat, in a case in which an occupant head portion contacts the outer peripheral side of an airbag that has been inflated and expanded accompanying an oblique collision, rotation around an axis, that runs along the vertical direction of the occupant head portion, of the occupant head portion can be suppressed.

### BRIEF DESCRIPTION OF THE DRAWINGS

Exemplary embodiments of the present disclosure will be described in detail based on the following figures, wherein:

FIG. 1 is a side view in which a steering wheel, to which an airbag device for a driver's seat relating to an embodiment is applied, is viewed from a vehicle transverse direction outer side;

FIG. 2 is an enlarged sectional view cut along line F2-F2 shown in FIG. 3;

FIG. 3 is a rear view in which a driver's seat airbag that is shown in FIG. 1 is seen from a vehicle rear side;

FIG. 4 is an exploded perspective view showing the driver's seat airbag that is shown in FIG. 1;

FIG. 5 is a drawing in which the driver's seat airbag that is shown in FIG. 1 is viewed from a vehicle upper side, and is a top view showing a state in which an occupant head portion has moved toward a vehicle front side;

FIG. 6 is a drawing in which the driver's seat airbag that is shown in FIG. 1 is viewed from the vehicle upper side, and is a top view showing a state in which the occupant head portion has moved toward a vehicle obliquely front side;

FIG. 7A is a top view that corresponds to FIG. 6 and shows a driver's seat airbag relating to a comparative example;

FIG. 7B is a top view that corresponds to FIG. 6 and shows the driver's seat airbag relating to the comparative example; and

FIG. 8 is an enlarged plan sectional view of main portions of FIG. 6.

### DETAILED DESCRIPTION

An airbag device 10 for a driver's seat that relates to an embodiment is described hereinafter with reference to the drawings. Note that arrow FR that is shown appropriately in the respective drawings indicates the vehicle front side (the vehicle longitudinal direction front side), and arrow UP indicates the vehicle upper side (the vehicle vertical direction upper side). Further, arrow LH indicates a vehicle transverse direction outer side (the left side when facing toward the vehicle front side). Further, longitudinal, vertical, and left and right in the following description mean the longitudinal of the vehicle longitudinal direction, the vertical of the vehicle vertical direction, and the left and right of the vehicle transverse direction, respectively, unless otherwise indicated.

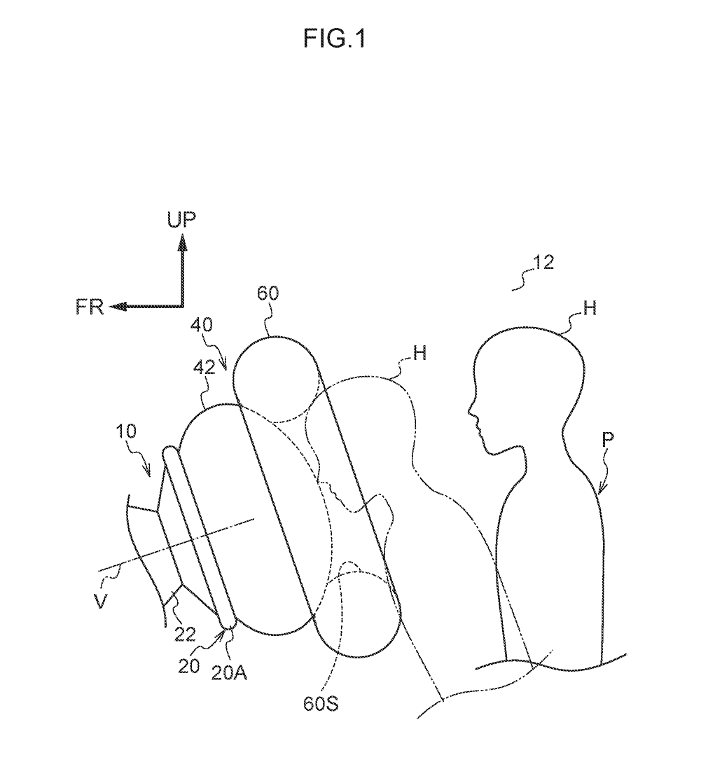

A steering wheel 20 of a vehicle, to which the airbag device 10 for a driver's seat relating to the present embodiment is applied, is shown in FIG. 1. Note that, in the present embodiment, the steering wheel 20 and an unillustrated driver's seat (front seat) are provided at the left side with respect to the vehicle transverse direction center of a cabin 12 at the vehicle front portion. On the other hand, an unillustrated front passenger's seat is provided at the right side with respect to the vehicle transverse direction center of the cabin 12 at the vehicle front portion.

A crash test dummy (a dummy mannequin) P that simulates an occupant is seated (set) in the driver's seat. A Hybrid-3 AM 50 (50th percentile U.S. adult male) that is World SID (internationally standardized side crash dummies: World Side Impact Dummies), a THOR dummy, or the like is used as the dummy P.

The dummy P is seated in the driver's seat in a standard seated posture that is prescribed by the crash test method. Further, the vehicle longitudinal direction position of a seat cushion of the driver's seat with respect to the steering wheel 20, and the angle of inclination of a seatback with respect to the seat cushion, are adjusted to standard set positions that correspond to the aforementioned seated posture of the dummy P. Note that, hereinafter, for convenience of explanation, the dummy P is called occupant P, and a head portion H of the dummy P is called occupant head portion H.

The steering wheel 20 is rotatably supported at a steering column 22 that projects-out toward the vehicle rear side (the driver's seat side) from an unillustrated instrument panel that forms the front wall portion of the cabin 12. A rotational axis V of the steering wheel 20 extends in the vehicle longitudinal direction, and is inclined, with respect to the vehicle longitudinal direction, so as to head toward the vehicle upper side while heading toward the vehicle rear side.

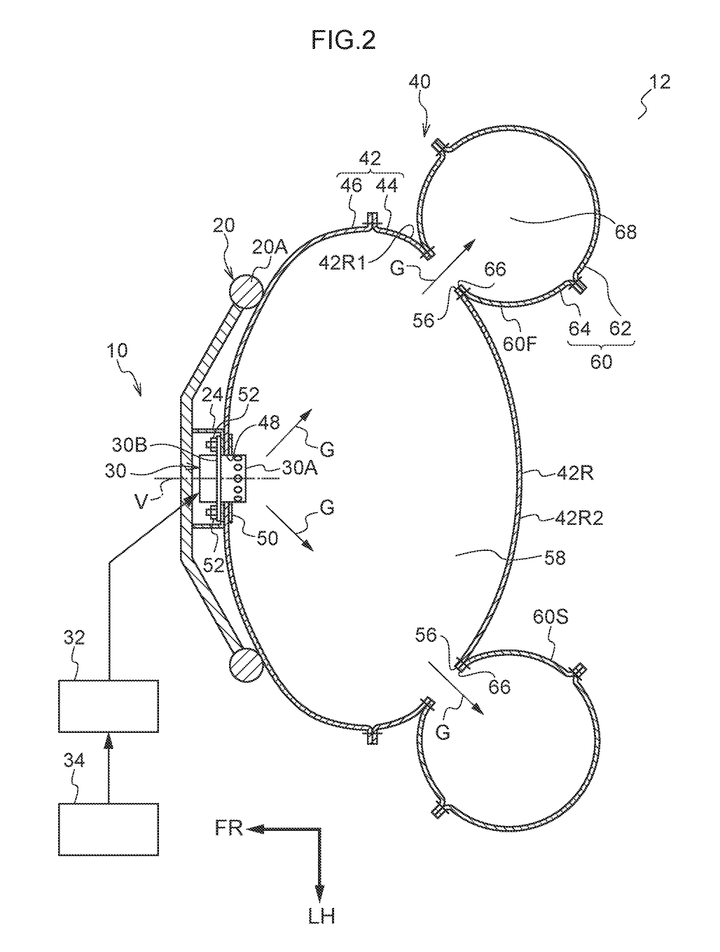

As shown in FIG. 2, the airbag device 10 for a driver's seat has an inflator 30 and a driver's seat airbag 40. The inflator 30 that serves as a gas supplying device has a gas jetting portion 30A that jets gas out into an interior 58 of a main body airbag 42 that is described later. This inflator 30 is mounted to the steering wheel 20 via a bracket 24.

An airbag ECU 32 that serves as a control device is electrically connected to the inflator 30. Operation of the inflator 30 is controlled by this airbag ECU 32, and the inflator 30 generates gas at the time of a collision or at the time when a collision is predicted. Concretely, a collision sensor 34 is electrically connected to the airbag ECU 32.

The collision sensor 34 can sense or predict various types of front collisions such as an oblique collision and a small overlap collision. This collision sensor 34 outputs, to the airbag ECU 32, a collision signal (collision information) that expresses that a collision has been sensed or predicted. On the basis of the collision signal inputted from the collision sensor 34, the airbag ECU 32 operates the inflator 30 at the time of a collision or at the time when a collision is predicted, and causes gas to be jetted-out from the gas jetting portion 30A.

Note that what is called “small overlap collision” here means a form of a collision in which a collision body collides with the vehicle front surface at further toward a vehicle transverse direction outer side than a front side member.

The driver's seat airbag 40 has the main body airbag 42 and an annular airbag 60. This driver's seat airbag 40 is accommodated, together with the inflator 30, in a state of being folded-up within an unillustrated steering wheel pad that is provided at the steering wheel 20. Note that an unillustrated tear portion, that is ruptured accompanying the inflation and expansion of the driver's seat airbag 40, is formed in the steering wheel pad at the portion thereof that faces the occupant head portion H.

The main body airbag 42 receives a supply of gas from the inflator 30, and is inflated and expanded at the vehicle rear side of the steering wheel 20. In other words, the main body airbag 42 is inflated and expanded between a rim 20A of the steering wheel 20 and the head portion H of the occupant P who is seated in the driver's seat.

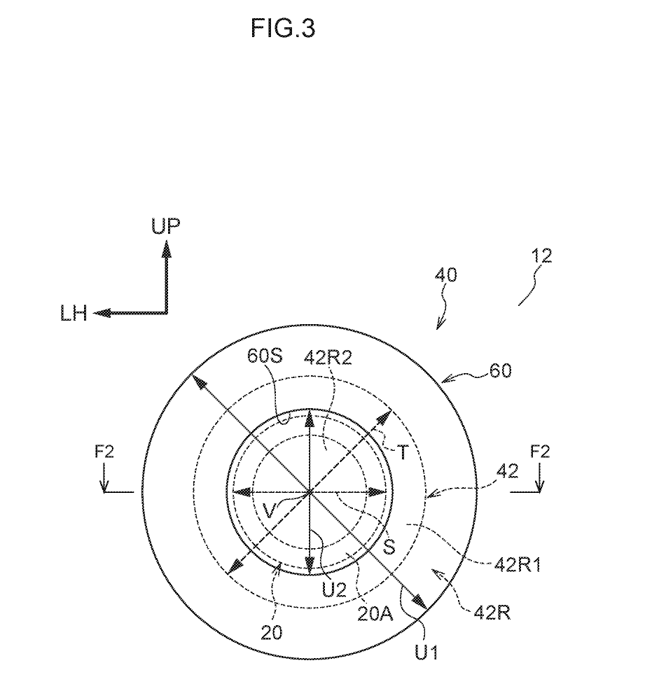

As shown in FIG. 3, the main body airbag 42 is formed in a circular shape when the inflated and expanded state of the main body airbag 42 is viewed from the axial direction rear side of the steering wheel 20 (the axial direction rear side of the rotational axis V). In other words, as seen from the axial direction rear side of the steering wheel 20, the main body airbag 42 is inflated and expanded in a circular shape. The main body airbag 42 in the following description means the main body airbag 42 in its inflated and expanded state, unless otherwise indicated.

Further, when viewing the main body airbag 42 from the axial direction rear side of the steering wheel 20, outer diameter (hereinafter called “main body outer diameter”) T of the main body airbag 42 is set to be greater than outer diameter S of the rim 20A of the steering wheel 20 (T>S). The annular airbag 60 is connected to an outer peripheral portion 42R1 of a rear surface 42R that is at the vehicle rear side of the main body airbag 42.

The annular airbag 60 receives a supply of gas from the main body airbag 42 accompanying the inflation and expansion of the main body airbag 42, and is inflated and expanded toward the vehicle rear side from the outer peripheral portion 42R1 of the main body airbag 42. More concretely, the annular airbag 60 receives a supply of gas from the inflator 30 via the main body airbag 42, and is inflated and expanded toward the vehicle rear side from the outer peripheral portion 42R1 of the main body airbag 42. Note that the annular airbag 60 in the following description means the annular airbag 60 that is in the inflated and expanded state, unless otherwise indicated.

Further, the annular airbag 60 is formed in an annular shape when the annular airbag 60 is viewed from the axial direction rear side of the steering wheel 20. Further, when the annular airbag 60 is viewed from the axial direction rear side of the steering wheel 20, the annular airbag 60 is formed in an annular shape at which outer diameter U1 is greater than the main body outer diameter T of the main body airbag 42 (U1>T) and inner diameter U2 is smaller than the main body outer diameter T (U2<T).

A central region of the rear surface 42R of the main body airbag 42 is exposed at the inner side of an inner peripheral surface 60S of the annular airbag 60. This central region of the rear surface 42R is contact region (restraining region) 42R2 that is contacted by the occupant head portion H that has moved toward the vehicle front side accompanying any of various types of front collisions.

Here, as shown in FIG. 2, plural connection holes 56 are formed in the outer peripheral portion 42R1 of the main body airbag 42. Concretely, the main body airbag 42 has, in an inflated and expanded state, an occupant-side main body base cloth 44 that is disposed at the occupant P side, and an opposite-occupant-side main body base cloth 46 that is disposed at the steering wheel 20 axial direction opposite side with respect to the occupant P, i.e., is disposed at the steering wheel 20 side.

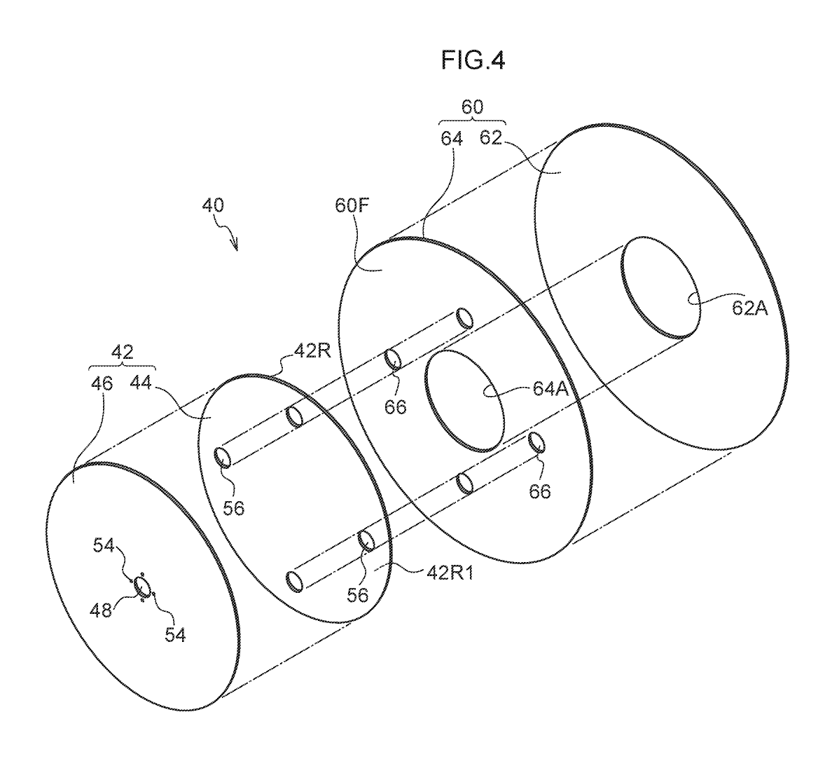

As shown in FIG. 4, the occupant-side main body base cloth 44 and the opposite-occupant-side main body base cloth 46 are formed in circular shapes in planarly expanded states. Further, the occupant-side main body base cloth 44 and the opposite-occupant-side main body base cloth 46 are joined together by sewing in a state in which the respective outer peripheral edge portions thereof are superposed on one another. Due thereto, the main body airbag 42 is formed in the shape of a bag.

As shown in FIG. 2, an insert hole 48 that is circular is formed in the central portion of the opposite-occupant-side main body base cloth 46. The gas jetting portion 30A of the inflator 30 is inserted in the insert hole 48. Further, the gas jetting portion 30A is inserted in a ring plate 50 that is disposed at the inner surface side (the rear surface side) of the opposite-occupant-side main body base cloth 46. Stud bolts, that pass-through the opposite-occupant-side main body base cloth 46 and are fixed by nuts 52 to a flange portion 30B of the inflator 30, are provided at the ring plate 50. Note that plural mounting holes 54 (see FIG. 4) through which the stud bolts pass are formed in the opposite-occupant-side main body base cloth 46 at the periphery of the insert hole 48.

The rear surface at the vehicle rear side of the occupant-side main body base cloth 44 forms the rear surface 42R of the main body airbag 42. The plural connection holes 56 are formed in the outer peripheral portion 42R1 of the rear surface 42R of the occupant-side main body base cloth 44. The plural connection holes 56 are through-holes that are circular and that pass-through the occupant-side main body base cloth 44 in the thickness direction thereof. The plural connection holes 56 are made to be the same size (diameter). As shown in FIG. 4, these connection holes 56 are disposed with an interval therebetween in the peripheral direction of the main body airbag 42. Note that, in the present embodiment, four of the connection holes 56 are disposed at a uniform interval in the peripheral direction of the main body airbag 42 (the annular airbag 60), at the outer peripheral portion 42R1 of the main body airbag 42.

On the other hand, plural supply holes 66, that are connected to (communicate with) the plural connection holes 56 of the main body airbag 42, are formed in a front surface 60F of the vehicle front side (the main body airbag 42 side) of the annular airbag 60. Concretely, the annular airbag 60 has, in the inflated and expanded state, an occupant-side annular base cloth 62 that is disposed at the occupant P side, and an opposite-occupant-side annular base cloth 64 that is disposed at the steering wheel 20 axial direction opposite side with respect to the occupant P, i.e., is disposed at the main body airbag 42 side.

The occupant-side annular base cloth 62 and the opposite-occupant-side annular base cloth 64 are formed in annular shapes in planarly expanded states, and through-holes 62A, 64A are formed in the central portions thereof, respectively. Further, the occupant-side annular base cloth 62 and the opposite-occupant-side annular base cloth 64 are joined together by sewing in a state in which the respective outer peripheral edge portions thereof are superposed on one another, and are joined together by sewing in a state in which the respective inner peripheral edge portions thereof are superposed on one another. Due thereto, the annular airbag 60 is formed in a toroid shape (a donut shape).

The front surface at the vehicle front side of the opposite-occupant-side annular base cloth 64 forms the front surface 60F of the annular airbag 60. The plural supply holes 66 are formed in the opposite-occupant-side annular base cloth 64. The plural supply holes 66 are through-holes that are circular and that pass-through the opposite-occupant-side annular base cloth 64 in the thickness direction thereof. The plural supply holes 66 are made to be the same size (diameter). These supply holes 66 are disposed with an interval therebetween in the peripheral direction of the annular airbag 60 (the main body airbag 42). Note that, in the present embodiment, at the front surface 60F of the annular airbag 60, four of the supply holes 66 are disposed at a uniform interval in the peripheral direction of the annular airbag 60, in correspondence with the four connection holes 56 of the main body airbag 42.

As shown in FIG. 2, the peripheral edge portions of the supply holes 66 of the annular airbag 60 are sewn and joined to the peripheral edge portions of the connection holes 56 of the main body airbag 42. Due thereto, the interior 58 of the main body airbag 42 and an interior 68 of the annular airbag 60 are connected together (communicate with one another) via the plural connection holes 56 and supply holes 66. As a result, gas (arrows G), that is supplied from the inflator 30 to the interior 58 of the main body airbag 42, is supplied to the annular airbag 60 via the plural connection holes 56 and supply holes 66.

Operation of the present embodiment is described next.

As shown in FIG. 2, when the airbag ECU 32 senses or predicts any of various types of collisions on the basis of a collision signal from the collision sensor 34, the airbag ECU 32 operates the inflator 30. Due thereto, gas is supplied from the gas jetting portion 30A of the inflator 30 to the interior 58 of the main body airbag 42, and the main body airbag 42 is inflated an expanded at the vehicle rear side of the steering wheel 20. At this time, the steering wheel pad that is not illustrated is ruptured by the inflation pressure of the main body airbag 42.

Further, when gas is supplied from the inflator 30 to the interior 58 of the main body airbag 42, gas is supplied from the interior 58 of the main body airbag 42 via the plural connection holes 56 and supply holes 66 to the interior 68 of the annular airbag 60, as shown by arrows G Due thereto, the annular airbag 60 is inflated and expanded toward the vehicle rear side from the outer peripheral portion 42R1 of the main body airbag 42.

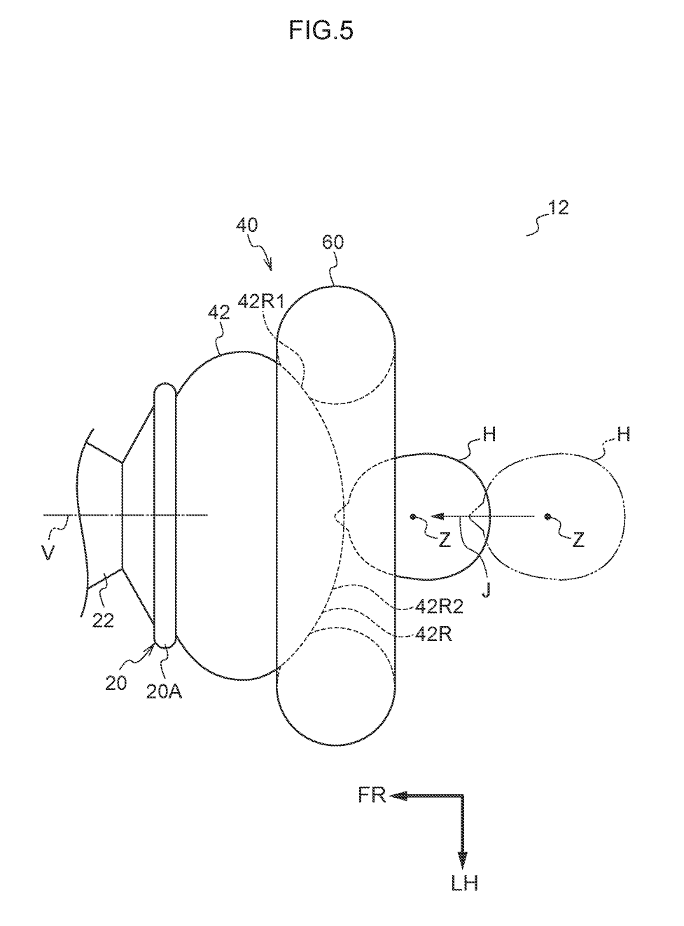

Further, at the time of a full overlap collision with respect to the vehicle front surface (a front collision), as shown by arrow J in FIG. 5, the occupant head portion H moves toward the vehicle front side with respect to the cabin 12. The occupant head portion H passes-through the inner side of the annular airbag 60 (within the inner peripheral circle), and contacts the central portion of the contact region 42R2 of the main body airbag 42. Due thereto, the occupant head portion H is restrained by the contact region 42R2 of the main body airbag 42.

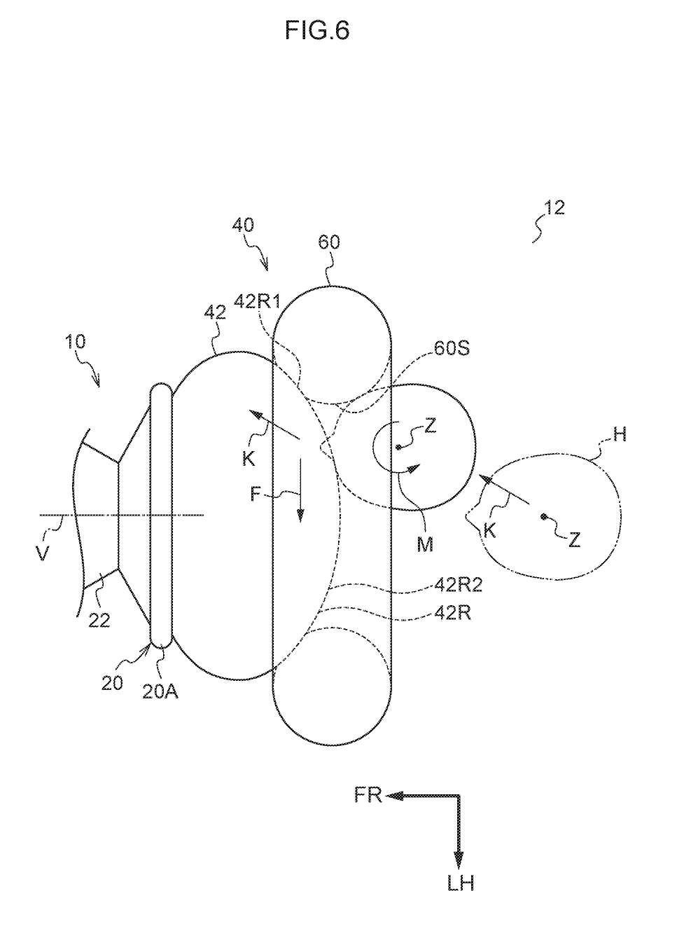

In contrast, at the time of an oblique collision with respect to the front passenger's seat side, as shown by arrow K in FIG. 6, the occupant head portion H of the occupant P who is seated in the driver's seat moves toward a vehicle obliquely front side toward the region of the collision of the vehicle front surface. Concretely, as shown by arrow K, the occupant head portion H moves toward the vehicle front side and the vehicle transverse direction right side (the vehicle transverse direction central side) with respect to the cabin 12. The occupant head portion H passes-through the inner side of the annular airbag 60 (within the inner peripheral circle), and, as shown by arrow K, contacts the outer peripheral side of the contact region 42R2 of the main body airbag 42. Or, the occupant head portion H contacts both the outer peripheral side of the main body airbag 42 and the inner peripheral surface 60S of the annular airbag 60.

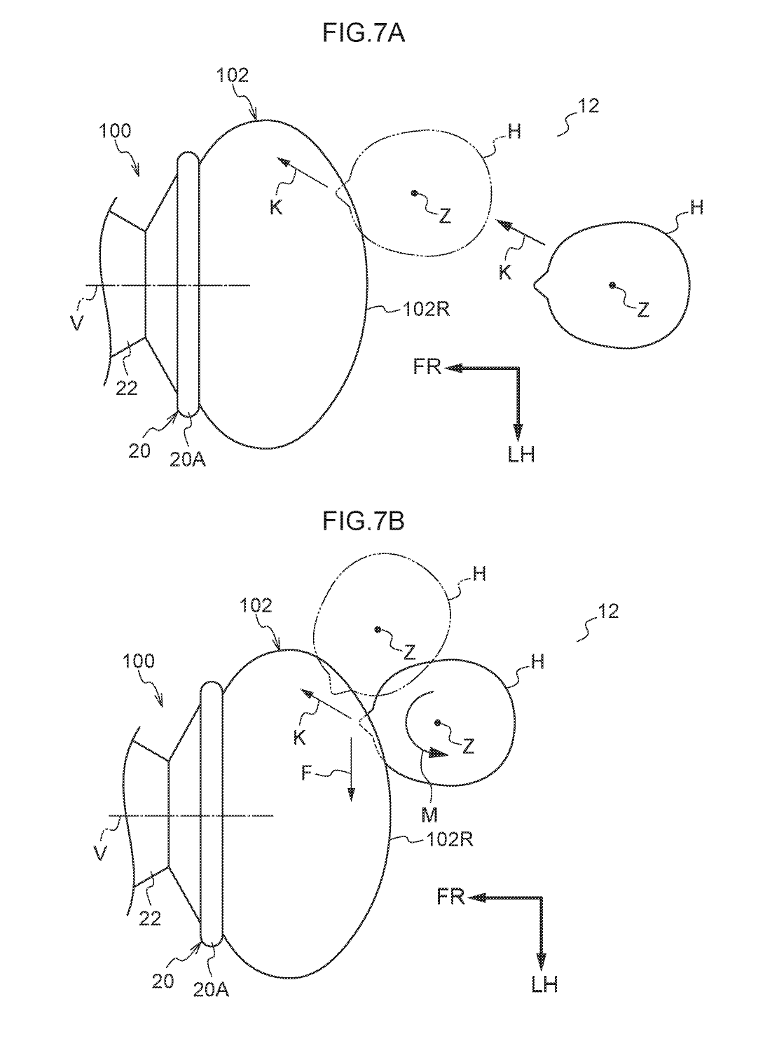

Here, an airbag device for a driver's seat relating to a comparative example is described in order to further clarify the operation of the airbag device 10 for a driver's seat relating to the present embodiment. As shown in FIG. 7A and FIG. 7B, in an airbag device 100 for a driver's seat relating to the comparative example, accompany any of various types of collisions, a driver's seat airbag 102 is inflated and expanded at the vehicle rear side of the steering wheel 20. Note that the airbag device 100 for a driver's seat does not have a structure corresponding to the annular airbag 60 of the present embodiment.

At the time of an oblique collision with respect to the front passenger's seat, as shown by arrow K in FIG. 7A, the occupant head portion H moves toward a vehicle obliquely front side toward the region of the collision of the vehicle front surface. Due thereto, as shown by the two-dot chain line, the occupant head portion H contacts the outer peripheral side of a rear surface (contact region) 102R of the driver's seat airbag 102. In this case, the occupant head portion H moves toward the vehicle transverse direction right side along the rear surface 102R of the driver's seat airbag 102, and there is the possibility that the occupant head portion H will contact an interior fitting part such as an unillustrated instrument panel or the like. Further, as shown by the two-dot chain line in FIG. 7B, there is the possibility that the occupant head portion H will rotate around axis Z that runs along the vertical direction of the occupant head portion H.

More concretely, as shown by arrow K in FIG. 7B, when the occupant head portion H contacts the outer peripheral side of the rear surface 102R of the driver's seat airbag 102, frictional force F that is directed toward the vehicle transverse direction left side (the arrow LH side) is generated at the portion of contact of the occupant head portion H with the rear surface 102R. Moment M, that rotates the occupant head portion H around the axis Z such that the occupant head portion H faces the vehicle transverse direction left side, is generated by the frictional force F. Therefore, there is the possibility that the occupant head portion H will rotate around the axis Z as shown by the two-dot chain line.

In contrast, in the airbag device 10 for a driver's seat relating to the present embodiment, as shown in FIG. 6, the annular airbag 60 is connected to the outer peripheral portion 42R1 of the main body airbag 42. Further, when, as shown by arrow K, the occupant head portion H moves toward a vehicle obliquely front side with respect to the cabin 12 accompanying an oblique collision with respect to the front passenger's seat side, the occupant head portion H passes-through the inner side of the annular airbag 60 and contacts the outer peripheral side of the contact region 42R2 of the main body airbag 42. Or, the occupant head portion H, that has contacted the inner peripheral surface 60S of the annular airbag 60, is pushed further against this inner peripheral surface 60S.

At this time, when, due to the aforementioned moment M, the occupant head portion H rotates or starts to rotate around the axis Z such that the occupant head portion H faces the vehicle transverse direction left side, the right side surface of the occupant head portion H is pushed-against the inner peripheral surface 60S at the vehicle transverse direction right side of the annular airbag 60. Due to the right side surface of the occupant head portion H being received by the inner peripheral surface 60S of the annular airbag 60, contact between the occupant head portion H and an interior fitting part, such as the unillustrated instrument panel or the like, is suppressed.

Further, when the occupant head portion H contacts the contact region 42R2 of the main body airbag 42, the main body airbag 42 is compressed, and gas at the interior 58 of the main body airbag 42 is supplied via the plural connection holes 56 and supply holes 66 (see FIG. 2) to the interior 68 of the annular airbag 60. Due thereto, the annular airbag 60 is inflated and expanded at an early stage, and, therefore, the occupant head portion H can be restrained by the inner peripheral surface 60S of the annular airbag 60 that has been inflated and expanded to a predetermined internal pressure.

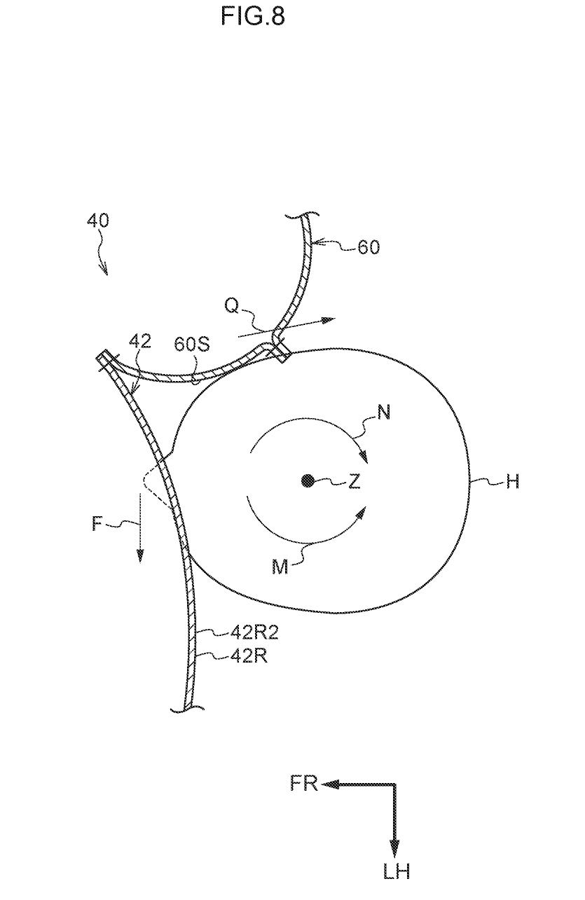

Moreover, rotation of the occupant head portion H around the axis Z is suppressed due to the right side surface of the occupant head portion H being received by the inner peripheral surface 60S of the annular airbag 60. Moreover, as shown in FIG. 8, frictional force Q that is directed toward the vehicle rear side is generated at the portion, that contacts the inner peripheral surface 60S of the annular airbag 60, of the occupant head portion H. A moment N, that rotates the occupant head portion H around the axis Z such that the occupant head portion H faces the vehicle transverse direction right side, is generated by the frictional force Q. Namely, the moment N that cancels-out the aforementioned moment M is generated at the occupant head portion H. As a result, rotation of the occupant head portion H around the axis Z is suppressed.

Further, the inflated and expanded state, in which the annular airbag 60 is seen from the axial direction rear side of the steering wheel 20, is formed in an annular shape at which the outer diameter U1 is greater than the main body outer diameter T of the main body airbag 42 and the inner diameter U2 is smaller than the main body outer diameter T. Due thereto, while the thickness (the size) in the radial direction of the annular airbag 60 that is in the inflated and expanded state is ensured, collapsing-in of the annular airbag 60 toward the vehicle transverse direction right side (radial direction outer side), that accompanies the contact between the occupant head portion H and the annular airbag 60, is suppressed.

Moreover, even in a case in which the main body airbag 42 and the annular airbag 60 inflate and expand in a state in which the steering wheel 20 has been rotated, the inner peripheral surface 60S of the annular airbag 60 is expanded at the vehicle transverse direction both sides of the main body airbag 42. Namely, the occupant head portion H can be received by the inner peripheral surface 60S of the annular airbag 60 regardless of the angle of rotation of the steering wheel 20.

Further, the plural supply holes 66, that are disposed with an interval therebetween in the peripheral direction of the annular airbag 60, are formed in the annular airbag 60. Gas is supplied via these supply holes 66 from the interior 58 of the main body airbag 42 to the interior 68 of the annular airbag 60. As a result, the annular airbag 60 is inflated and expanded.

Therefore, the pressure within the annular airbag 60 (the internal pressure) at the time when the occupant head portion H contacts the inner peripheral surface 60S of the annular airbag 60 can be adjusted by changing the number of or the size of the plural supply holes 66. Namely, the force by which the inner peripheral surface 60S of the annular airbag 60 restrains the occupant head portion H can be adjusted by changing the number or the size of the plural supply holes 66. Accordingly, rotation of the occupant head portion H around the axis Z can be suppressed more effectively.

Further, in the present embodiment, as described above, at the time of a full overlap collision, the occupant head portion H that has moved toward the vehicle front side passes-through the inner side of the annular airbag 60 and contacts the contact region 42R2 of the main body airbag 42. Namely, at the time of a full overlap collision, the occupant head portion H can be restrained by the main body airbag 42 without being affected by the annular airbag 60. Accordingly, while the performance of restraining the occupant head portion H at the time of a full overlap collision is ensured, rotation of the occupant head portion H around the axis Z at the time of an oblique collision can be suppressed.

Note that operation and effects that are similar to those described above in the present embodiment can be obtained also at the time of an oblique collision or a small overlap collision with respect to the driver's seat side, and are not limited to collisions with respect to the front passenger's seat side.

Further, in the above-described embodiment, the steering wheel 20 and the unillustrated driver's seat are provided at the left side with respect to the vehicle transverse direction center of the cabin 12 at the vehicle front portion, but the above-described embodiment is not limited to this. The steering wheel 20 and the unillustrated driver's seat may be provided at the right side with respect to the vehicle transverse direction center of the cabin 12 at the vehicle front portion.

Although an embodiment of the present disclosure has been described above, the present disclosure is not limited to this embodiment, and the embodiment and various modified examples may be used by being combined together appropriately. Further, the present disclosure can, of course, be embodied in various forms within a scope that does not depart from the gist thereof.

What is claimed is:

1. An airbag device for a driver's seat, comprising:
an inflator that is provided at a steering wheel, and that generates gas at a time of a collision or a time when a collision is predicted;
a main body airbag that receives a supply of gas from the inflator and is inflated and expanded at a vehicle rear side of the steering wheel, and whose inflated and expanded state, as seen from an axial direction rear side of the steering wheel, is formed in a circular shape; and
an annular airbag that is connected to an outer peripheral portion of a rear surface at a vehicle rear side of the main body airbag, and that receives a supply of gas from the main body airbag and is inflated and expanded from the outer peripheral portion toward a vehicle rear side, and whose inflated and expanded state, as seen from the axial direction rear side of the steering wheel, is formed in an annular shape having an outer diameter that is larger than an outer diameter of the main body airbag and having an inner diameter that is smaller than the outer diameter of the main body airbag.

2. The airbag device for a driver's seat of claim 1, wherein a plurality of supply holes, that are disposed with an interval therebetween in a peripheral direction of the annular airbag and through which gas is supplied from the main body airbag, are formed in the annular airbag.

3. The airbag device for a driver's seat of claim 1, wherein
the main body airbag is inflated and expanded between the steering wheel and an occupant head portion of an occupant seated in a driver's seat, and
an inner peripheral surface of the annular airbag in the inflated and expanded state is a surface that is contacted by the occupant head portion that has moved toward a vehicle obliquely front side accompanying a front collision.

4. The airbag device for a driver's seat of claim 3, wherein a central region of the rear surface of the main body airbag that is in the inflated and expanded state is exposed at an inner side of the annular airbag that is in the inflated and expanded state.

5. The airbag device for a driver's seat of claim 4, wherein the central region of the rear surface of the main body airbag that is in the inflated and expanded state is a contact region that is contacted by the occupant head portion that has moved toward a vehicle front side accompanying a front collision.

6. The airbag device for a driver's seat of claim 1, wherein, when the inflated and expanded state of the main body airbag is viewed from the axial direction rear side of the steering wheel, the outer diameter of the main body airbag is larger than an outer diameter of a rim of the steering wheel.

7. The airbag device for a driver's seat of claim 2, wherein the plurality of supply holes are formed in a front surface that is at a vehicle front side of the annular airbag.

8. The airbag device for a driver's seat of claim 7, wherein a plurality of connection holes, that are disposed with an interval therebetween in a peripheral direction of the main body airbag and that are connected to the plurality of supply holes respectively, are formed in an outer peripheral portion of the rear surface of the main body airbag.

9. The airbag device for a driver's seat of claim 8, wherein peripheral edge portions of the supply holes at the front surface of the annular airbag are joined to peripheral edge portions of the connection holes at the rear surface of the main body airbag.

10. The airbag device for a driver's seat of claim 2, wherein the plurality of supply holes are disposed at a uniform interval in the peripheral direction of the annular airbag.

11. The airbag device for a driver's seat of claim 2, wherein the plurality of supply holes are made to be the same size.

12. The airbag device for a driver's seat of claim 1, wherein the annular airbag receives a supply of gas from the inflator via the main body airbag, and is inflated and expanded.
